(19) United States
(12) Patent Application Publication
(10) Pub. No.: US 2010/0177925 A1
(43) Pub. Date: Jul. 15, 2010

(54) Speaker Device

(75) Inventors: Akihiko Furuto, Yamagata (JP); Hiroyuki Dohi, Yamagata (JP)

Correspondence Address: ARENT FOX LLP, 1050 CONNECTICUT AVENUE, N.W., SUITE 400, WASHINGTON, DC, 20036, US

(73) Assignees: PIONEER CORPORATION, Tokyo (JP); TOHOKU PIONEER CORPORATION, Tendo-shi, Yamagata (JP)

(21) Appl. No.: 12/301,955

(22) PCT Filed: May 24, 2006
(86) PCT No.: PCT/JP2006/310397

§ 371 Date: Nov. 21, 2008

(51) Int. Cl. H04R 9/06

(52) U.S. Cl. 381/398

(57) ABSTRACT

A speaker device includes a diaphragm having an inner rim connected to a voice coil bobbin and an outer rim connected to a frame through an edge, wherein the diaphragm is shaped so that a peak portion is formed with an acute angle folded back between the inner rim and the outer rim which are positioned at an acoustic radiation side in comparison with the peak portion. The cross-sectional shape of the diaphragm extending from the peak portion to the inner rim is formed with a convex shape toward an acoustic radiation side, and also that of the diaphragm extending from the peak portion to the outer rim is formed with substantially straight shape or convex shape toward the acoustic radiation side. The speaker device lower in profile allows high-quality sound to be reproduced, in particular, the high range of frequency characteristic of the sound pressure to be improved.

### BACKGROUND OF THE INVENTION

1. Field of the Invention

The present invention relates to a speaker device.

2. Description of the Related Art

Speaker devices mounted on audio equipment such as an audio system are so-called electric-acoustic transducers which convert a sound signal (electric energy) from an amplifier to sound (acoustic energy). By operation principle, speaker devices are broadly classified into electrodynamic type, electrostatic type, piezoelectric type, discharge type, electromagnetic type, and so on. The current mainstream is of electrodynamic type (dynamic type) which satisfies various conditions including reproduction frequency band and conversion efficiency.

One of the known examples of conventional electrodynamic speaker devices is a so-called cone speaker. Aside from single use as a part of, for example, an audio system, speaker devices are often attached and mounted in narrow spaces such as the interior of an automobile door, a cabinet of a flat type electronic display, and cabinets of various other configurations. In this case, the speaker devices is to be formed with a low profile, the height being suppressed as much as possible so as to facilitate the attachment into the cabinets of limited dimensions. Cone speakers are difficult to reduce in height, however.

For example, Patent Document 1 discloses a speaker device which includes a diaphragm which has a peak portion between its inner rim and outer rim. That is, since the diaphragm has a cross-sectional shape of being folded back at the peak portion, this speaker device can be reduced in profile as compared to speaker devices which have a typical cone-shaped diaphragm.

[Patent Document 1] Japanese Patent Publication No. 3643855

By the way, the speaker device according to the Patent document 1 as mentioned above has an inadequacy that a sound pressure level, especially high range of frequency characteristic thereof, deteriorates, as a result of the diaphragm being simply folded back at the peak portion. Then, the improvement of the high range of frequency characteristic in the use of the above-mentioned speaker device is expected.

Besides, because of miniaturization, space saving, and the like of the cabinets for speaker devices to be mounted on, even smaller sizes and lower profiles have been demanded of the speaker devices. The foregoing speaker devices use an outer magnet type magnetic circuit to drive the diaphragm of the foregoing configuration. Since the outer magnet type magnetic circuit has a ring-shaped magnet and a ring-shaped plate radially outside a voice coil, it has been difficult to reduce the speaker devices in size and in profile.

Besides, the ring-shaped magnet of the outer magnet type magnetic circuit has a relatively large weight. If the ring-shaped magnet is simply miniaturized, the magnetic fluxes in the magnetic gap might decrease to lower the force for driving the diaphragm, with a drop in the quality of the reproduced sound.

### SUMMARY OF THE INVENTION

One of the objects of the present invention addresses such a problem by making a speaker device smaller than heretofore in size, in profile, and in weight, improving the high-frequency characteristic of sound pressure level, even in the case of using a diaphragm having a peak portion between the inner rim and outer rim thereof, and reproducing high-quality sound and so on.

To achieve the foregoing object, the present invention comprises at least configurations according to the following respective independent claims.

The invention according to the first aspect is concerned with a speaker device having a frame, a diaphragm including an inner rim connected to a voice coil bobbin and an outer rim connected to the frame through an edge, and a damper including an outer rim connected to the frame. The diaphragm comprises a peak portion formed with an acute angle folded back between the inner rim and the outer rim in the diaphragm in which the inner rim and the outer rim are positioned at an acoustic radiation side in comparison with the peak portion. A cross-sectional shape of the diaphragm between the peak portion and the inner rim side is formed with convex shape toward the acoustic radiation side, while a cross-sectional shape of the diaphragm between the peak portion and the outer rim side is formed with substantially straight shape or convex shape toward the acoustic radiation side. The peak portion is connected to the damper at near an inner rim of the damper.

A speaker device of the invention according to the second aspect has a frame, a diaphragm including an inner rim connected to a voice coil bobbin and an outer rim connected to the frame through an edge, and a damper including an outer rim connected to the frame. The diaphragm comprises a peak portion formed with an acute angle folded back between the inner rim and the outer rim in the diaphragm in which the inner rim and the outer rim are positioned at an acoustic radiation side in comparison with the peak portion. The peak portion is connected to the damper at near an inner rim of the damper. A length along a diameter direction of the speaker device from the inner rim to the peak portion is smaller than the length along the diameter direction from the peak portion to the outer rim.

A speaker device of the invention according to the third aspect has a frame, a diaphragm including an inner rim connected to a voice coil bobbin and an outer rim connected to the frame through an edge, and a damper including an outer rim connected to the frame. The diaphragm comprises a peak portion formed with an acute angle folded back between the inner rim and the outer rim in the diaphragm in which the inner rim and the outer rim are positioned at an acoustic radiation side in comparison with the peak portion. The peak portion is connected to the damper at near an inner rim of the damper. The outer rim of the diaphragm has a diameter equal to or smaller than four times of a height of the outer rim of the diaphragm.

### BRIEF DESCRIPTION OF THE DRAWINGS

These and other objects and advantages of the present invention will become clearly understood from the following description with reference to the accompanying drawings, wherein:

FIG. 1 is a diagram for explaining a speaker device 100 according to an embodiment of the present invention, a front view of the speaker device 100 as seen from the front side (acoustic radiation side);

FIG. 2 is a sectional view of the speaker device 100 shown in FIG. 1, taken along the line A-A;

FIG. 3 is a sectional view for explaining a speaker device 100a according to another embodiment of the present invention;

FIGS. 4(A) to 4(C) are diagrams for explaining a diaphragm of the speaker device 100 shown in FIG. 1, FIG. 4(A) being a sectional view for explaining a concrete example of the cross-sectional shape of the diaphragm of the speaker device 100, FIG. 4(B) being a sectional view for explaining another concrete example of the cross-sectional shape of the diaphragm of the speaker device 100, FIG. 4(C) being a diagram for explaining the cross-sectional shape of the diaphragm shown in FIG. 4(A) in detail;

FIGS. 5(A) and 5(B) are diagrams for explaining the results of simulation on the magnetic flux density in magnetic circuits;

FIG. 6 is a chart for explaining the distribution of the magnetic flux density in the magnetic gaps 4g of the magnetic circuits 4 shown in FIGS. 5(A) and 5(B);

FIG. 7(A) is a diagram showing a diaphragm to be compared in which an inner diaphragm portion 81 is formed with a cross section of generally straight shape and an outer diaphragm portion 82 is formed with a cross section of concave shape to the acoustic radiation side, and FIG. 7(B) is a chart showing the result of simulation on the sound pressure level of the speaker device which uses the diaphragm shown in FIG. 7(A);

FIG. 8(A) is a diagram showing a diaphragm in which the inner diaphragm portion 81 is formed with a cross section of convex shape and the outer diaphragm portion 82 is formed with a cross section of convex shape toward the acoustic radiation side, and FIG. 8(B) is a chart showing the result of simulation on the sound pressure level of the speaker device which uses the diaphragm shown in FIG. 8(A);

FIG. 9(A) is a diagram showing a diaphragm in which the inner diaphragm portion 81 is formed with a cross section of convex shape and the outer diaphragm portion 82 is formed with a cross section of generally straight shape, and FIG. 9(B) is a chart showing the result of simulation on the sound pressure level of the speaker device which uses the diaphragm shown in FIG. 9(A);

FIG. 10(A) is a diagram showing a diaphragm in which the inner diaphragm portion 81 is formed with a cross section of generally straight shape and the outer diaphragm portion 82 is formed with a cross section of generally straight shape, the inner diaphragm portion 81 having a length A (r81) greater than the length B (r82) of the outer diaphragm portion 82, and FIG. 10(B) is a chart showing the result of simulation on the sound pressure level of the speaker device which uses the diaphragm shown in FIG. 10(A);

FIG. 11(A) is a diagram showing a diaphragm in which the inner diaphragm portion 81 is formed with a cross section of generally straight shape and the outer diaphragm portion 82 is formed with a cross section of generally straight shape, the inner diaphragm portion 81 having the same length A (r81) as the length B (r82) of the outer diaphragm portion 82, and FIG. 11(B) is a chart showing the result of simulation on the sound pressure level of the speaker device which uses the diaphragm shown in FIG. 11(A);

FIG. 12(A) is a diagram showing a diaphragm in which the inner diaphragm portion 81 is formed with a cross section of generally straight shape and the outer diaphragm portion 82 is formed with a cross section of generally straight shape, the inner diaphragm portion 81 having a length A (r81) smaller than the length B (r82) of the outer diaphragm portion 82, and FIG. 12(B) is a chart showing the result of simulation on the sound pressure level of the speaker device which uses the diaphragm shown in FIG. 12(A);

FIG. 13(A) is a diagram showing a diaphragm in which the inner diaphragm portion 81 is formed with a cross section of generally straight shape and the outer diaphragm portion 82 is formed with a cross section of generally straight shape, the outer rim of the diaphragm being formed with a diameter (outer diameter) 4.8 times of the height d8 of the outer rim of the diaphragm, and FIG. 13(B) is a chart showing the result of simulation on the sound pressure level of the speaker device which uses the diaphragm shown in FIG. 13(A);

FIG. 14(A) is a diagram showing a diaphragm in which the inner diaphragm portion 81 is formed with a cross section of generally straight shape and the outer diaphragm portion 82 is formed with a cross section of generally straight shape, the outer rim of the diaphragm having a diameter (outer diameter) 3.8 times of the height d8 of the outer rim of the diaphragm, and FIG. 14(B) is a chart showing the result of simulation on the sound pressure level of the speaker device which uses the diaphragm shown in FIG. 14(A); and

FIG. 15(A) is a diagram showing a diaphragm in which the inner diaphragm portion 81 is formed with a cross section of generally straight shape and the outer diaphragm portion 82 is formed with a cross section of generally straight shape, the outer rim of the diaphragm having a diameter (outer diameter) 3.2 times of the height d8 of the outer rim of the diaphragm, and FIG. 15(B) is a chart showing the result of simulation on the sound pressure level of the speaker device which uses the diaphragm shown in FIG. 15(A).

### DETAILED DESCRIPTION OF THE PREFERRED EMBODIMENTS

A speaker device according to an embodiment of the present invention includes a frame, a diaphragm having an inner rim connected to a voice coil bobbin and an outer rim connected to the frame through an edge, and a damper having an outer rim connected to the frame. The diaphragm is shaped so that a peak portion thereof is formed with an acute angle folded back between the inner rim and the outer rim. The inner rim and the outer rim are positioned at an acoustic radiation side in comparison with the peak portion. A cross-sectional shape of the diaphragm between the peak portion and the inner rim is formed with a convex shape toward the acoustic radiation side. In addition, a cross-sectional shape of the diaphragm between the peak portion and the outer rim is formed with a substantially straight shape or a convex shape toward the acoustic radiation side. Further, the peak portion is connected to the damper at near an inner rim of the damper.

In the speaker device of the above configurations, the diaphragm is shaped so that a peak portion thereof is formed with an acute angle folded back between the inner rim and the outer rim which are positioned at an acoustic radiation side in comparison with the peak portion, a cross-sectional shape of the diaphragm between the peak portion and the inner rim side is formed with a convex shape toward the acoustic radiation side, and a cross-sectional shape of the diaphragm between the peak portion and the outer rim side is formed with generally straight shape or a convex shape toward the acoustic radiation side. Thus, even if the diaphragm is reduced in profile, it is possible to reproduce high-quality sound, and to improve the high frequency characteristic of sound pressure level.

Besides, a speaker device according to the other embodiment of the present invention includes a frame, a diaphragm having an inner rim connected to a voice coil bobbin and an outer rim connected to the frame through an edge, and a damper having an outer rim connected to the frame. The diaphragm is shaped so that a peak portion thereof is formed with an acute angle folded back between the inner rim and the outer rim which are in positioned at an acoustic radiation side in comparison with the peak portion. The length extending from the inner rim to the peak portion along a direction of diameter of the speaker device is smaller than the length extending from the peak portion to the outer rim along the same direction.

In the speaker device of the above configurations that a peak portion of the diaphragm is formed with an acute angle folded back between the inner rim and the outer rim, which are positioned at an acoustic radiation side in comparison with the peak portion, and the length extending along a direction of the diameter of the speaker from the inner rim to the peak portion is smaller than the length extending from the peak portion to the outer rim in the same way, it is possible to reproduce high-quality sound and, in particular, to improve the high frequency characteristic of sound pressure level even if the diaphragm is reduced in profile.

Besides, a speaker device according to further embodiment of the present invention includes a frame, a diaphragm having an inner rim connected to a voice coil bobbin and an outer rim connected to a frame through an edge, wherein the diaphragm is shaped so that a peak portion thereof is formed with an acute angle folded back between the inner rim and the outer rim, which are positioned at an acoustic radiation side in comparison with the peak portion, and wherein the outer rim has a diameter equal to or less than 4 times of height for the outer rim of the diaphragm.

In the speaker device of the above configurations, the diaphragm is shaped so that a peak portion thereof is formed with an acute angle folded back between the inner rim and the outer rim, which are positioned at an acoustic radiation side in comparison with the peak portion, and the outer rim has a diameter equal to or less than 4 times of height for the outer rim of the diaphragm, it is possible to reproduce high-quality sound and, in particular, to improve the high frequency characteristic of sound pressure level, even if the diaphragm is reduced in profile.

Hereinafter, a speaker device according to an embodiment of the present invention will be described with reference to the drawings.

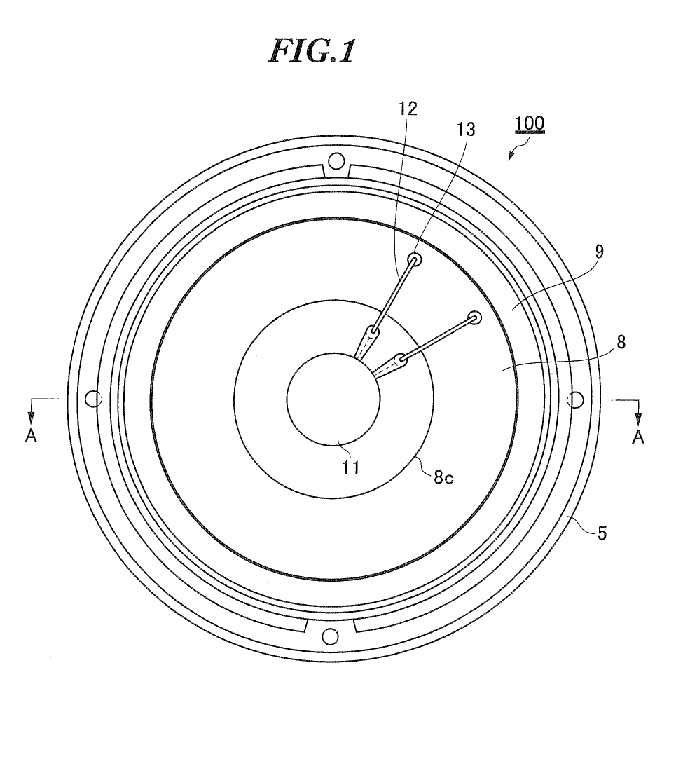

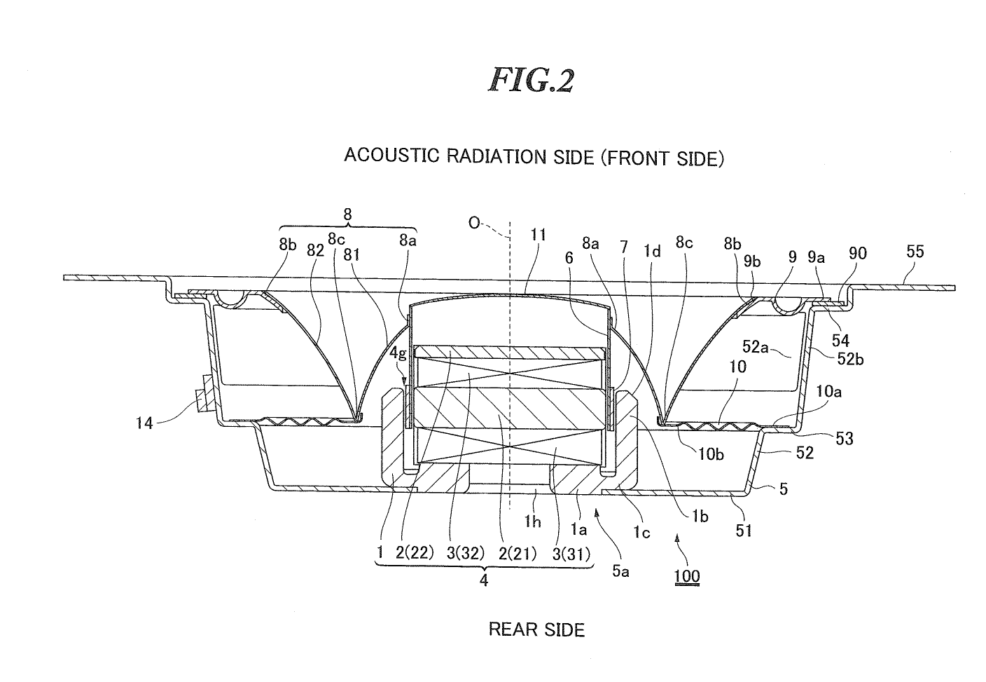

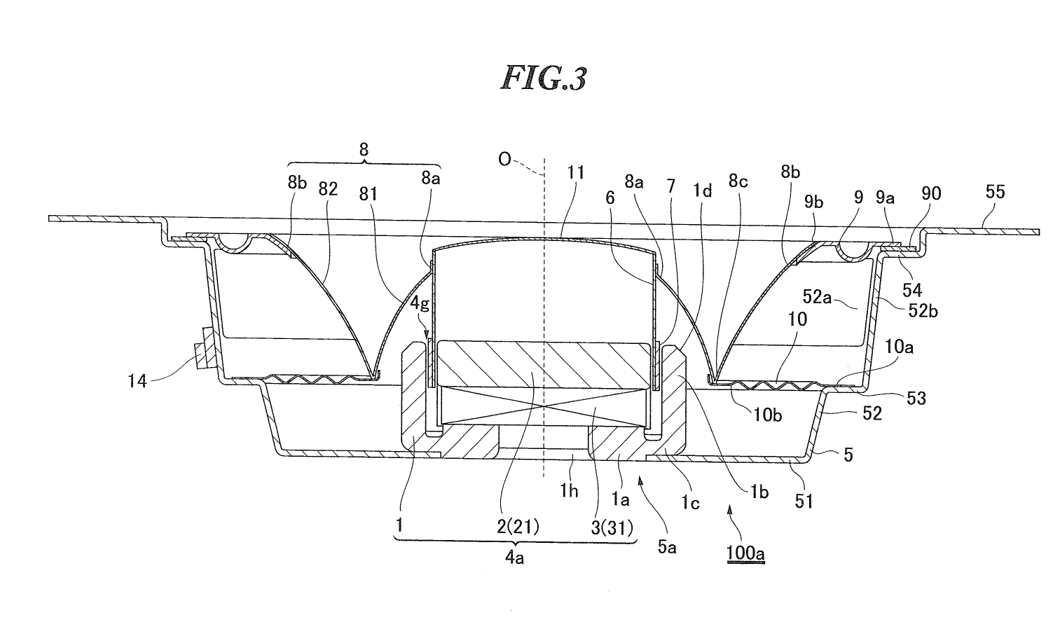

FIG. 1 is a diagram for explaining a speaker device 100 according to an embodiment of the present invention. More specifically, FIG. 1 is a front view of the speaker device 100 as seen from the front side (acoustic radiation side). FIG. 2 is a sectional view of the speaker device 100 shown in FIG. 1, taken along the line A-A. FIG. 3 is a sectional view for explaining a speaker device 100a according to another embodiment of the present invention.

The speaker device 100 includes: an inner magnet type magnetic circuit 4 including a yoke 1, plates 2, and magnets 3; a frame (speaker frame) 5; a voice coil 7 wound and arranged around a voice coil bobbin 6; a diaphragm 8; an edge 9; a damper 10; a center cap unit 11; and leads 12.

The inner magnet type magnetic circuit 4 corresponds to an embodiment of the inner magnet type magnetic circuit according to the present invention. The diaphragm 8 corresponds to an embodiment of the diaphragm according to the present invention. The yoke 1 corresponds to an embodiment of the yoke according to the present invention. The frame 5 corresponds to an embodiment of the frame according to the present invention.

The magnetic circuit 4 according to the present embodiment includes the yoke 1, the two magnets 3 (31, 32), and the two plates 2 (21, 22). The plate 2 (21) is also referred to as a center plate.

The yoke 1 has a bottom portion 1a which is connected to the bottom of the magnet 3 (31), and a side portion 1b which is shaped so as to spread out radially from this bottom portion 1a, bend to the direction of acoustic radiation (front), and extend from the bend 1c to beside the plate 2 (21). The bottom portion 1a and the side portion 1b of the yoke 1 are formed integrally with each other. The yoke 1 according to the present embodiment has a slope portion 1d which is formed on the outer corner of the end of the side portion 1b at the acoustic radiation side. A hole portion 1h is formed in the center of the yoke 1. The yoke 1 may be made of such materials as inorganic materials, metals, iron, and other magnetic materials.

In the magnetic circuit 4, as shown in FIG. 2, the plate 2 (21) is arranged between the magnet 3 (31) and the magnet 3 (32), and the plate 2 (22) is arranged on the magnet 3 (32). The magnets 3 (31, 32) are arranged so that the same poles are opposed to each other. The magnetic circuit 4 of such a configuration is referred to as repulsion magnetic circuit. The use of the repulsion magnetic circuit provides the effects of creating a relatively high magnetic flux density in the magnetic gap 4g, providing increased sensitivity, and so on.

The magnets 3 (31, 32) may be made of materials such as permanent magnets including neodymium type, samarium-cobalt type, alnico type, and ferrite type magnets. The plates 2 (21, 22) may be made of materials such as iron and other metals, and magnetic materials.

In the magnetic circuit 4 according to the present embodiment, the yoke 1, the magnet 3 (31), the plate 2 (21), the magnet 3 (32), and the plate 2 (22) are formed concentrically with respect to the center axis o. More specifically, they are closely arranged on the same axis, at overlapping positions along the direction of the center axis o.

The magnet 3 (31), the plate 2 (21), the magnet 3 (32), and the plate 2 (22) may be formed in a ring shape. The magnetic circuit 4 may be a radial magnetic circuit having so-called radial ring magnets, in which the magnets 3 (31, 32) of the foregoing configuration are magnetized so that the same poles are opposed to each other along the thickness direction (the direction of vibration). This creates a magnetic gap between the inner and outer sides of the magnets 3 (31, 32) so that the flowing direction of the magnetic fluxes coincides with the direction of the magnetic fluxes which flow inside the magnetic circuit 4. The use of the radial magnetic circuit for the magnetic circuit 4 provides the effects of allowing improved magnetic efficiency, allowing lower profile, allowing miniaturization, and the like.

The magnetic circuit 4 according to the present embodiment can also reduce magnetic leakage because of the structure that the magnet 3 (31) is surrounded by the yoke 1 which is made of iron or the like.

As shown in FIG. 2, the magnetic circuit 4 has the magnetic gap 4g for driving the voice coil 7. The magnetic fluxes caused by the magnets 3 (31, 32) are concentrated to this magnetic gap 4g. More specifically, the magnetic gap 4g is formed between the inner periphery of the side portion 1b of the yoke 1 and the outer periphery of the plate 2 (21), with a generally uniform interval across the entire circumference.

As described above, the magnetic circuit 4 according to the present embodiment uses a so-called repulsion magnetic circuit, having the two magnets 3 (31, 32) arranged with the same poles opposed to each other, whereas it is not limited to this configuration. For example, as shown in FIG. 3, a speaker device 100a may have a magnetic circuit 4a which is configured so that the magnet 3 (31) is arranged on a pole portion 1a of the yoke 1, and the plate 2 (21) is arranged on the magnet 3 (31). The speaker device 100a according to the configuration shown in FIG. 3 has the effects of allowing lower profile, allowing smaller size, and the like, because of the provision of the magnetic circuit 4a which consists of the yoke 1, the plate 2 (21), and the magnet 3 (31),

As shown in FIGS. 1 and 2, the frame 5 has a rear flat portion (bottom portion) 51, on the center of which the magnetic circuit 4 is arranged. An opening 5a is formed in the center of the rear flat portion 51. The frame 5 has a cone-shaped portion 52 which is formed to bend from the outer rim of the rear flat portion 51 to the acoustic radiation side. A flat portion 53 for an outer rim 10a of the damper 10 to be fixed to is formed in the middle of the cone-shaped portion 52 of the frame 5. A flat portion 54 for an outer rim 9a of the edge 9 to be fixed to, either directly or through a joint member 90 is formed near the top of the cone-shaped portion 52 on the front side. A flange 55 is formed on the outer periphery of the frame 5. The cone-shaped portion 52 has one or more window portions 52a and arm portions 52b between the flat portions 53 and 54.

In the frame 5 according to the present embodiment, the rear flat portion 51, the cone-shaped portion 52, the flat portion 53, the flat portion 54, and the flange 55 are formed integrally with each other.

The voice coil 7 is formed, for example, by winding an electric wire around the voice coil bobbin 6 of cylindrical shape, and is fixed to the voice coil bobbin 6. At least part of the voice coil 7 is arranged in the magnetic gap 4g of the magnetic circuit 4 so as to be capable of vibrations.

The center cap unit 11 is formed with an outer diameter generally the same as the inner diameter of the voice coil bobbin 6, for example. The center cap unit 11 is firmly fixed to the voice coil bobbin 6 with an adhesive or the like, thereby being connected with the voice coil bobbin 6. The center cap unit 11 according to the present embodiment is formed in a convex shape to the acoustic radiation side. The center cap unit 11 is not limited to a particular shape, and may be formed in a concave shape in order to reduce the speaker device in profile.

The diaphragm 8 may be made of various materials such as resin and other polymer materials, paper materials, and metal materials. The diaphragm 8 has a ring-like acoustic radiation surface which extends from an inner rim 8a to an outer rim 8b. The inner rim 8a has a center hole portion for establishing connection with the voice coil bobbin 6. The voice coil bobbin 6 is fit into the center hole portion of the diaphragm 8 and firmly fixed with an adhesive or the like, whereby the inner rim 8a of the diaphragm 8 is connected to near the end of the voice coil bobbin 6 on the acoustic radiation side. The outer rim 8b of the diaphragm 8 is attached to the frame 5 through the edge 9.

The edge 9 is formed in a ring shape, for example. Various edges may be employed for the edge 9, including a roll edge, V edge, corrugation edge, and flat edge. For the edge 9 according to the present embodiment, a roll edge is employed. The edge 9 has both appropriate compliance and rigidity, and the inner rim 9b of the edge 9 is firmly fixed to the outer rim 8b of the diaphragm 8 with an adhesive or the like so that the edge 9 is connected with the diaphragm 8. As described above, the outer rim 9a of the edge 9 is firmly fixed to the flat portion 54 of the frame 5 directly or through the joint member 90, thereby being connected with the frame 5. The outer rim 8b of the diaphragm 8 is thus connected to the frame 5 through the edge 9. The edge 9 thereby supports the outer rim of the diaphragm 8 elastically.

As shown in FIGS. 1 and 2, the diaphragm 8 is shaped so that a peak portion 8c is formed between the inner rim 8a and the outer rim 8b which are positioned at the acoustic radiation side in comparison with the peak portion 8c. The peak portion 8c of the diaphragm 8 is fixed to an inner rim 10b of the damper 10 with an adhesive or the like.

The damper 10 is formed, for example, by immersing a cloth into resin, followed by heat forming. Various shapes of dampers may be used for the damper 10, including a concentrically-corrugated circular damper. The damper 10 has both appropriate compliance and rigidity. The outer rim 10a of the damper 10 is connected to the frame 5, and the peak portion 8c of the diaphragm 8 is supported by the inner rim 10b. As shown in FIG. 2, the inner rim 10b of the damper 10 according to the present embodiment is shaped so as to bend toward the acoustic radiation side and along the inclined surface of the diaphragm 8 as well, and is fixed to the peak portion 8c with an adhesive or the like. The inner rim 10b of the damper 10 and the peak portion 8c of the diaphragm 8 are therefore fixed to each other with reliability.

As shown in FIGS. 1 and 2, the speaker device 100 is also formed so that the damper 10, the flat portion 53 of the flame 5, the voice coil 7, the plate 2 (21), and the peak portion 8c of the diaphragm 8 are generally flush with each other.

In the speaker device 100 of the foregoing configuration, the peak portion 8c of the diaphragm 8 is set to the height of the damper 10. This can reduce variations in the height of the peak portion 8c of the diaphragm 8, thereby allowing high-quality sound reproduction. Setting the peak portion 8c of the diaphragm 8 to the height of the damper 10 also improves assembly workability.

The damper 10 of the foregoing configuration elastically supports the diaphragm 8, the center cap unit 11, the voice coil bobbin 6, and the voice coil 7 with the edge 9 at predetermined positions in the speaker when the speaker is not driven. The voice coil 7 and the voice coil bobbin 6 arranged in the magnetic gap 4g are also elastically retained in positions not in contact with the components of the magnetic circuit 4, such as the side portion 1b of the yoke 1.

The damper 10 also has the function of elastically supporting the center cap unit 11, the diaphragm 8, the voice coil bobbin 6, and the voice coil 7 along the direction of vibration (the direction of the center axis (o)) when the speaker is driven.

As described above, the yoke 1 has the slope portion 1d which is formed on the outer corner of the end of the side portion 1b at the acoustic radiation side. This can prevent the diaphragm 8 from coming into contact with the yoke 1 even when the speaker is driven and the diaphragm 8 vibrates along the direction of vibration (the direction of the center axis (o)).

Both ends of the voice coil 7 are extended along the voice coil bobbin 6 and the diaphragm 8, and electrically connected with a respective pair of leads 12, for example, near the inner rim of the diaphragm 8 as shown in FIG. 1.

The leads 12 are lead wires made of strands of a plurality of fine wires, for example, and have a high bending strength. The leads 12 are connected to an input terminal unit 14 which is fixed to the frame 5, through holes 13 which are formed in the diaphragm 8.

In the speaker device 100 of the foregoing configuration, when a sound signal is input to the input terminal unit 14, an electric current corresponding to the sound signal is supplied to the voice coil bobbin 6 through the leads 12. As a result, the voice coil bobbin 6 is electromagnetically driven in the magnetic gap 4g. Being supported by the edge 9 and the damper 10, the center cap unit 11 and the diaphragm 8 connected with the voice coil bobbin 6 are driven along the direction of piston vibrations, whereby acoustic energy corresponding to the sound signal is radiated from the diaphragm 8.

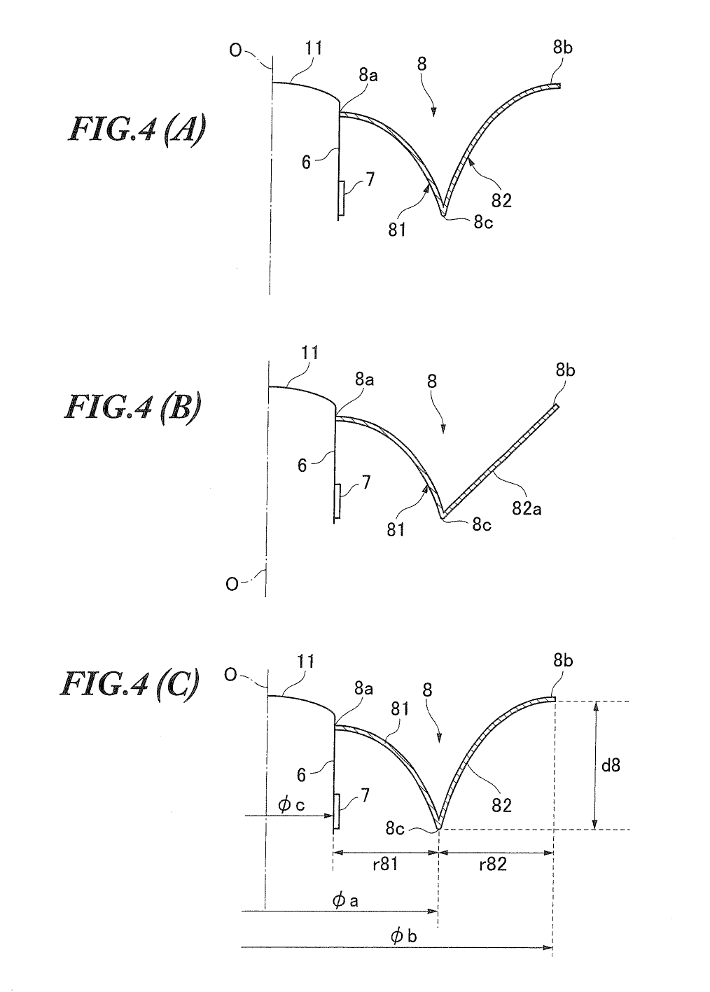

FIGS. 4(A) to 4(C) are diagrams for explaining the diaphragm of the speaker device 100 shown in FIG. 1. More specifically, FIG. 4(A) is a sectional view for explaining a concrete example of the cross-sectional shape of the diaphragm device 100. FIG. 4(B) is a sectional view for explaining another concrete example of the cross-sectional shape of the diaphragm device 100. FIG. 4(C) is a diagram for explaining the cross-sectional shape of the diaphragm shown in FIG. 4(A) in detail.

In order to suppress the overall height of the speaker device 100, to suppress divided vibration of the diaphragm 8 when driven, and to improve the sound pressure level at high frequencies, the diaphragm 8 according to the present embodiment has the following structure.

That is, as shown in FIGS. 1, 2, and 4(A) to 4(C), the diaphragm 8 is formed to have a fold between the inner rim 8a and the outer rim 8b, with this fold as the peak portion 8c.

This peak portion 8c is the top area of the fold of the diaphragm 8, being folded back at an acute angle so that the inner rim 8a and the outer rim 8b are positioned at the acoustic radiation side in comparison with the peak portion 8C.

For example, as shown in FIGS. 4(A) to 4(C), the diaphragm 8 has an inner diaphragm portion 81 which is formed on the side of the inner rim 8a with respect to the peak portion 8c of the diaphragm 8, and an outer diaphragm portion 82 which is formed on the side of the outer rim 8b with respect to the peak portion 8c of the diaphragm 8. The inner diaphragm portion 81 and the outer diaphragm portion 82 are formed integrally with each other.

More specifically, as shown in FIG. 4(A), the inner diaphragm portion 81 on the side of the inner rim 8a with respect to the peak portion 8c of the diaphragm 8 is formed with a cross section of convex shape toward the acoustic radiation side. The outer diaphragm portion 82 on the side of the outer rim 8b with respect to the peak portion 8c of the diaphragm 8 is formed with a cross section of convex shape toward the acoustic radiation side.

As shown in FIG. 4(B), the inner diaphragm portion 81 of the diaphragm 8 may be formed with a cross section of convex shape toward the acoustic radiation side while the outer diaphragm portion 82a may be formed with a cross section of generally straight shape.

As shown in FIG. 4(C), the peak portion 8c of the diaphragm 8 has a diameter φa which is smaller than the diameter φb of the outer rim 8b of the diaphragm 8. The diameter φa of the peak portion 8c is greater than the diameter φc of the voice coil bobbin 6.

As shown in FIG. 4(C), the diaphragm 8 according to the present embodiment is desirably formed so that the radial length r81 from the inner rim 8a to the peak portion 8c is smaller than the radial length r82 from the peak portion 8c to the outer rim 8b.

In the diaphragm 8 according to the present embodiment, as shown in FIG. 4(C), the outer rim 8b of the diaphragm 8 desirably has a diameter φb no greater than four times the height d8 of the outer rim 8b of the diaphragm 8. The height d8 of the outer rim 8b of this diaphragm 8 refers to the distance from the peak portion 8c of the diaphragm 8 to the outer rim 8b of the diaphragm 8 along the direction of acoustic radiation.

In the speaker device 100 of the foregoing configuration, the diaphragm extending from the inner rim 8a to the outer rim 8b is folded back at the peak portion 8c. Then, the overall height of the diaphragm 8 is the height from the peak portion 8c to the inner rim 8a or the outer rim 8b. The overall height of the diaphragm 8 can thus be made smaller than that of a conventional cone-shaped diaphragm which has the same grille diameter (diaphragm diameter) and the same voice coil diameter (the inner rim 8a of the diaphragm 8).

Moreover, in the diaphragm 8 according to the present embodiment, the peak portion 8c of the diaphragm 8 is optimized in diameter φa with respect to the diameter φb of the outer rim 8b of the diaphragm 8. The inner diaphragm portion 81 is formed in a convex shape, and the outer diaphragm portion 82 is formed with a cross section of convex shape or generally straight shape. The outer rim 8b of the diaphragm 8 is optimized in diameter pb and height d8. Such conditions make it possible to improve the reproduction frequency characteristic at high frequencies.

The diaphragm 8 may be formed under any one of the foregoing conditions, two conditions in combination, or the three conditions in combination, with the effect of improving the reproduction frequency characteristic at high frequencies.

That is, the speaker device 100 according to the present embodiment can provide the effects of reducing the speaker device heretofore in size, in profile, and in weight, and can reproduce sound in high quality as well.

Next, the inventor performed a computer-based simulation on the distribution of magnetic flux densities in the magnetic circuit 4, in order to confirm the performance of the magnetic circuit 4 of the speaker device 100 according to the embodiment of the present invention.

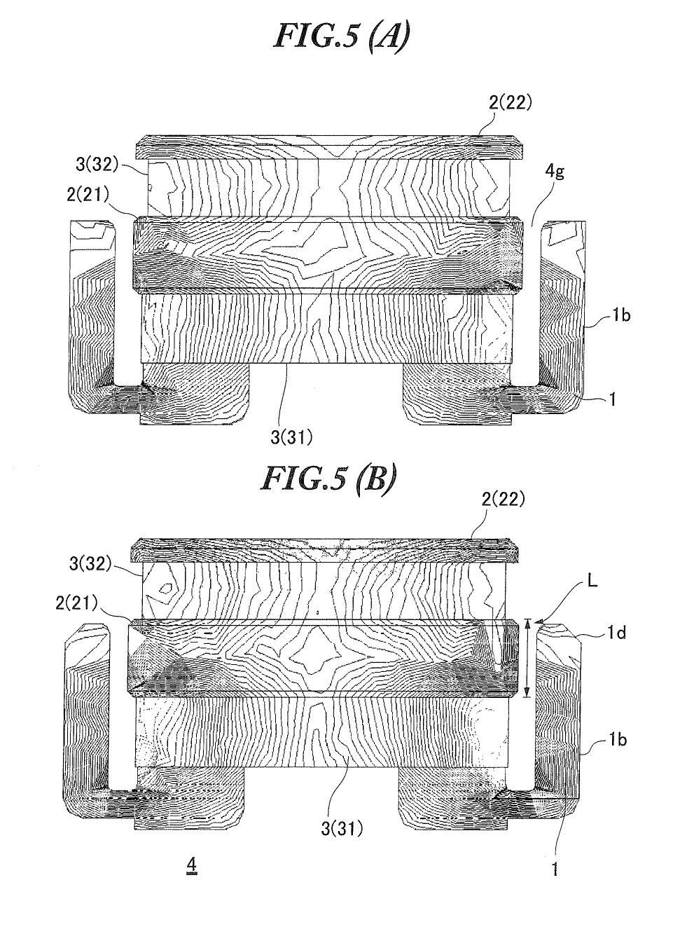

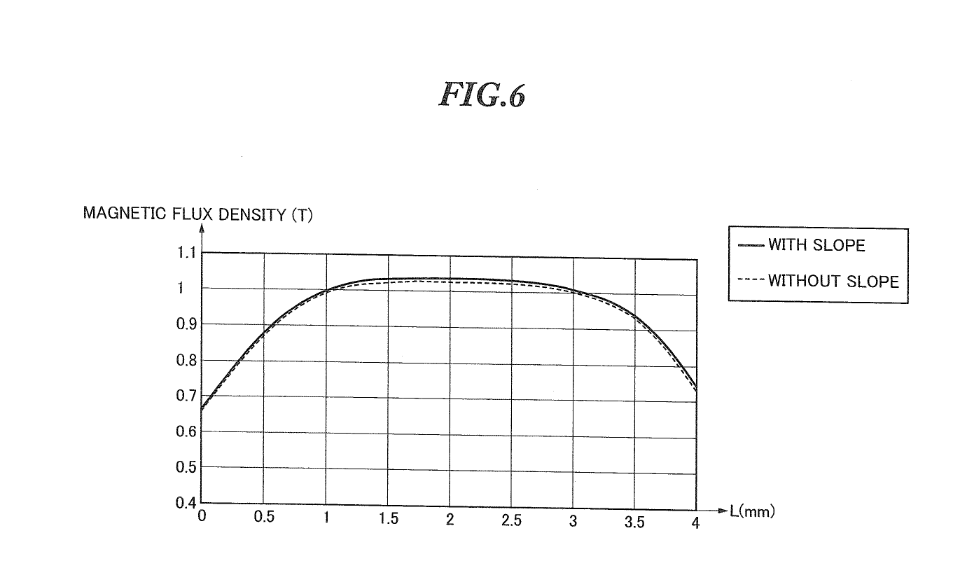

FIGS. 5(A) and 5(B) are diagrams for explaining the results of simulation on the magnetic flux density in magnetic circuits. More specifically, FIG. 5(A) is a diagram showing the distribution of magnetic fluxes in a magnetic circuit in which the yoke end has no slope portion. FIG. 5(B) is a diagram showing the distribution of magnetic fluxes in a magnetic circuit in which the yoke end has a slope portion. FIG. 6 is a chart for explaining the magnitude of the magnetic flux density in the magnetic gaps 4g of the magnetic circuits 4 shown in FIGS. 5(A) and 5(B). The vertical axis of this chart indicates the magnitude of the magnetic flux density (T: Tesla), and the horizontal axis indicates the position in the magnetic gap along the direction of vibration (mm). In FIG. 6, the dotted line represents the magnitude of the magnetic flux density in the magnetic circuit 4 having the structure shown in FIG. 5(A). The full line represents the magnitude of the magnetic flux density in the magnetic circuit 4 having the structure shown in FIG. 5(B). In FIG. 6, 0 mm corresponds to the vicinity of the boundary between the center plate 2 and the magnet 3 (31), 2 mm corresponds to the vicinity of the center of the center plate 2, and 4 mm corresponds to the vicinity of the boundary between the center plate 2 and the magnet 3 (32).

As shown in FIG. 5(A), it is confirmed that the magnetic fluxes concentrate on near the ends of the plate 2 (21) which is sandwiched between the magnet 3 (31) and the magnet 3 (32). It is also confirmed that magnetic leakage is prevented by the side portion 1b of the yoke 1. The use of this repulsion magnetic circuit allows a relatively high magnetic flux density in the magnetic gap 4g.

Moreover, as shown in FIG. 5(B), it is confirmed that the magnetic circuit 4 having the slope portion 1d at the end of the side portion 1b of the yoke 1 creates an improved flow of magnetic fluxes near the slope portion 1d as compared to the magnetic circuit shown in FIG. 5(A). It was also confirmed that the magnetic fluxes continue to flow near the ends of the magnet 3 (31) without closing up.

As shown in FIG. 6, it was confirmed that the magnetic circuits 4 reach the maximum values of the magnetic flux density (approximately 1.04 T) in the vicinity of the center (around 2 mm) of the center plate 2 (21), and the magnetic flux density is generally uniform in magnitude across around ±1 mm about the center. It was also confirmed that the magnetic flux density increases in magnitude when the slope portion 1d is formed on the end of the side portion 1b of the yoke 1 as shown by the full line, when compared to the case where no slope portion 1d is formed on the end of the side portion 1b of the yoke 1 as shown by the dotted line.

As described above, the magnetic circuit 4 may have the slope portion 1d on the end of the side portion 1b of the yoke 1. This can make the magnetic flux density in the magnetic gap 4g of the magnetic circuit 4 greater in magnitude.

As described above, since the slope portion 1d is formed on the outer corner of the end of the side portion 1b of the yoke 1 at the acoustic radiation side, the diaphragm 8 can also be prevented from coming into contact with the yoke 1 even when the speaker is driven and the diaphragm 8 vibrates along the direction of vibration (the direction of the center axis (o)).

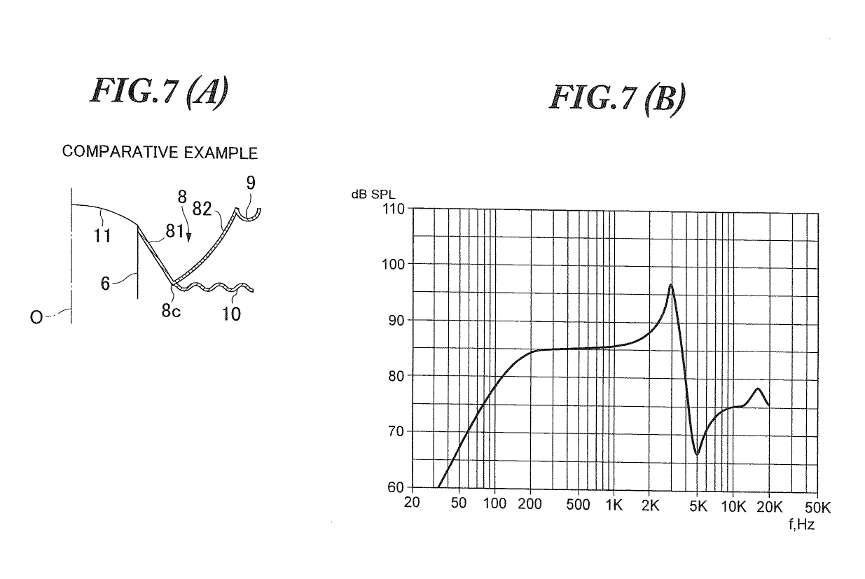

Next, in order to confirm the performance of the diaphragm of the speaker device 100 according to the embodiment of the present invention, the inventor made a study on diaphragms of different cross-sectional shapes and performed a simulation on the sound pressure levels (SPL) of speaker devices using those diaphragms. FIGS. 7 to 15 are diagrams showing the cross-sectional shapes of the diaphragms and the results of simulation on the sound pressure levels of the speaker devices using those diaphragms. Hereinafter, the sound pressure levels of the speakers will be described with reference to the diagrams.

[Optimization of Cross-Sectional Shape]

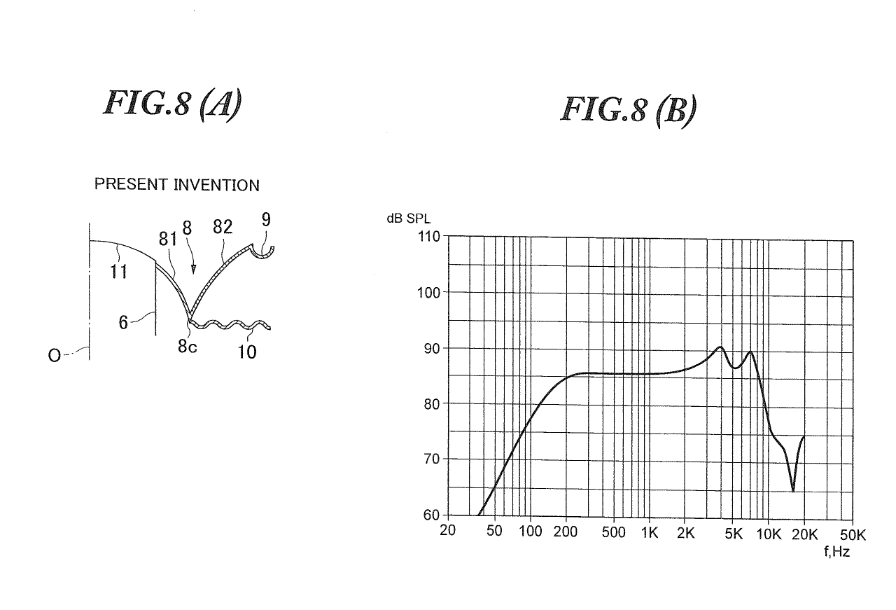

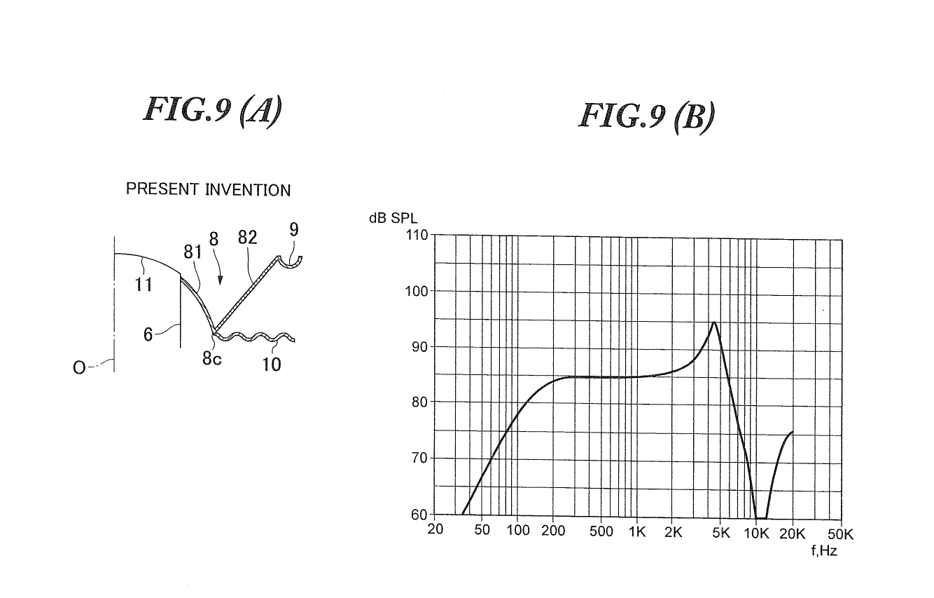

FIG. 7(A) is a diagram showing a diaphragm to be compared in which the inner diaphragm portion 81 is formed with a cross section of generally straight shape and the outer diaphragm portion 82 is formed with a cross section of concave shape to the acoustic radiation side. FIG. 7(B) is a chart showing the result of simulation on the sound pressure level of the speaker device which uses the diaphragm shown in FIG. 7(A). FIG. 8(A) is a diagram showing a diaphragm in which the inner diaphragm portion 81 is formed with a cross section of convex shape and the outer diaphragm portion 82 is formed with a cross section of convex shape toward the acoustic radiation side. FIG. 8(B) is a chart showing the result of simulation on the sound pressure level of the speaker device which uses the diaphragm shown in FIG. 8(A). FIG. 9(A) is a diagram showing a diaphragm in which the inner diaphragm portion 81 is formed with a cross section of convex shape and the outer diaphragm portion 82 is formed with a cross section of generally straight shape. FIG. 9(B) is a chart showing the result of simulation on the sound pressure level of the speaker device which uses the diaphragm shown in FIG. 9(A).

Initially, take the diaphragm to be compared in which the inner diaphragm portion 81 is formed with a cross section of generally straight shape and the outer diaphragm portion 82 is formed with a cross section of concave shape to the acoustic radiation side as shown in FIG. 7(A). As shown in FIG. 7(B), the sound pressure level is approximately 60 dB at frequencies of around 30 Hz. The sound pressure level increases from 30 Hz to 200 Hz to reach 85 dB at 200 Hz, shows a generally flat characteristic from 200 Hz to 1 kHz, and increases sharply from 1 kHz to reach a maximum value of approximately 97 dB at around 3 kHz. The sound pressure level then drops sharply from 3 kHz to 5 kHz to reach approximately 67 Hz at 5 kHz, increases from 5 kHz to 20 kHz, and shows a value of 75 dB at 20 kHz.

Now, take the diaphragm 8 according to the present invention in which the inner diaphragm portion 81 is formed with a cross section of convex shape and the outer diaphragm portion 82 is formed with a cross section of convex shape toward the acoustic radiation side as shown in FIG. 8(A). As shown in FIG. 8(B), the sound pressure level is approximately 60 dB at frequencies of around 30 Hz. The sound pressure level increases from 30 Hz to 200 Hz to reach 85 dB at 200 Hz, shows a generally flat characteristic from 200 Hz to 1 kHz, and increases from 1 kHz to reach a peak value of approximately 91 dB at around 4 kHz, followed by a decrease. The sound pressure level then reaches a peak value of approximately 91 dB at around 7 kHz, then decreases to 65 dB at approximately 15 kHz, increases from approximately 15 kHz to 20 kHz, and shows a value of 75 dB at 20 kHz.

As described above, it was confirmed that the diaphragm 8 according to the present invention shown in FIG. 8(A) has an improved frequency characteristic at high frequencies (for example, from approximately 3 kHz to 10 kHz or so) as compared to the comparative example shown in FIG. 7(A).

Now, take the diaphragm 8 according to the present invention in which the inner diaphragm portion 81 is formed with a cross section of convex shape and the outer diaphragm portion 82 is formed with a cross section of generally straight shape to the acoustic radiation side as shown in FIG. 9(A). As shown in FIG. 9(B), the sound pressure level is approximately 60 dB at frequencies of around 30 Hz. The sound pressure level increases from 30 Hz to 200 Hz to reach 85 dB at 200 Hz, shows a generally flat characteristic from 200 Hz to 1 kHz, and increases from 1 kHz to reach a peak value of approximately 95 dB at around 4.5 kHz. The sound pressure level then drops to 60 dB or less at around 11 kHz, and increases from approximately 11 kHz to 20 kHz to reach a value of 75 dB at 20 kHz.

As described above, it was confirmed that the diaphragm 8 according to the present invention shown in FIG. 9(A) has an improved frequency characteristic at high frequencies (for example, from approximately 3 kHz to 10 kHz or so) as compared to the comparative example shown in FIG. 7.

[Optimization of Length A (r81) of Inner Diaphragm Portion 81 and Length B (r82) of Outer Diaphragm Portion 82]

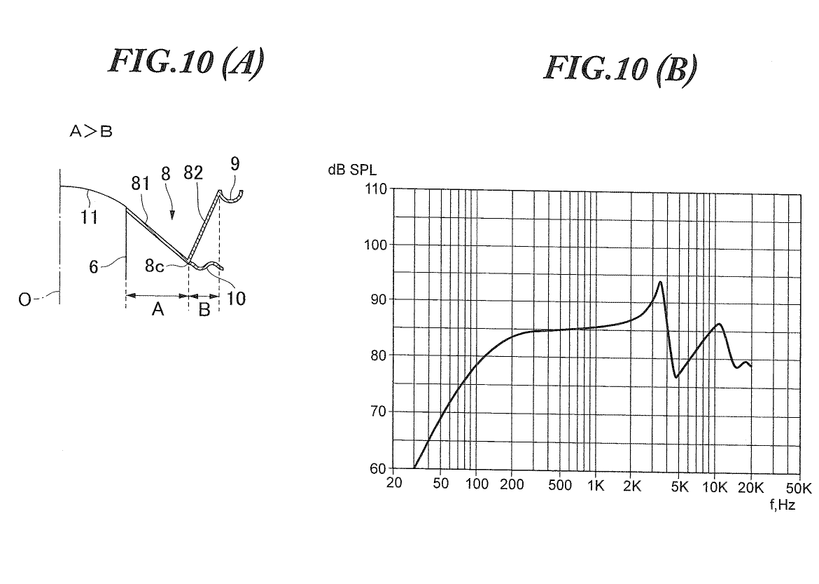

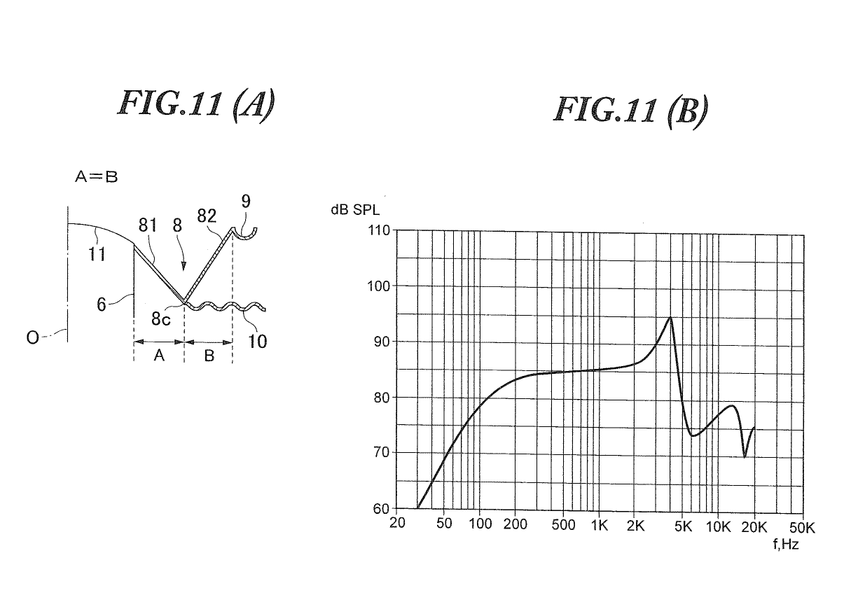

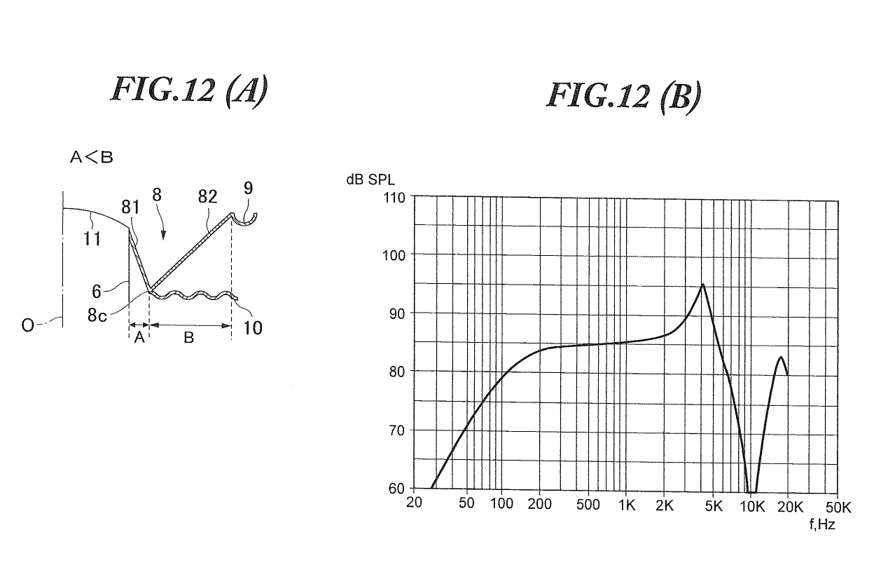

FIG. 10(A) is a diagram showing a diaphragm in which the inner diaphragm portion 81 is formed with a cross section of generally straight shape and the outer diaphragm portion 82 is formed with a cross section of generally straight shape, the inner diaphragm portion 81 having a length A (r81) greater than the length B (r82) of the outer diaphragm portion 82. FIG. 10(B) is a chart showing the result of simulation on the sound pressure level of the speaker device which uses the diaphragm shown in FIG. 10(A). FIG. 11(A) is a diagram showing a diaphragm in which the inner diaphragm portion 81 is formed with a cross section of generally straight shape and the outer diaphragm portion 82 is formed with a cross section of generally straight shape, the inner diaphragm portion 81 having the same length A (r81) as the length B (r82) of the outer diaphragm portion 82. FIG. 11(B) is a chart showing the result of simulation on the sound pressure level of the speaker device which uses the diaphragm shown in FIG. 11(A). FIG. 12(A) is a diagram showing a diaphragm in which the inner diaphragm portion 81 is formed with a cross section of generally straight shape and the outer diaphragm portion 82 is formed with a cross section of generally straight shape, the inner diaphragm portion 81 having a length A (r81) smaller than the length B (r82) of the outer diaphragm portion 82. FIG. 12(B) is a chart showing the result of simulation on the sound pressure level of the speaker device which uses the diaphragm shown in FIG. 12(A).

Next, as shown in FIGS. 10(A) and 10(B) to 12(A) and 12(B), the length A (r81) of the inner diaphragm portion 81 and the length B (r82) of the outer diaphragm portion 82 are optimized.

As shown in FIG. 12(B), it was confirmed that the high-frequency characteristic is improved when using the diaphragm in which the inner diaphragm portion 81 has a length A (r81) smaller than the length B (r82) of the outer diaphragm portion 82, as compared to the other cases. That is, the diaphragm 8 according to the present invention preferably uses one in which the length A (r81) of the inner diaphragm portion 81 is smaller than the length B (r82) of the outer diaphragm portion 82.

[Optimization of Outer Diameter and Height of Diaphragm]

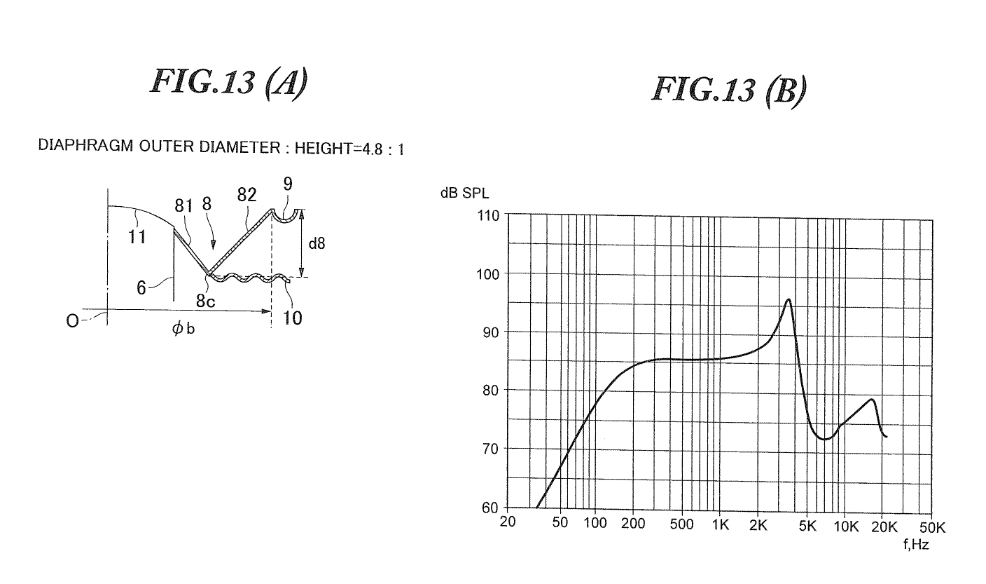

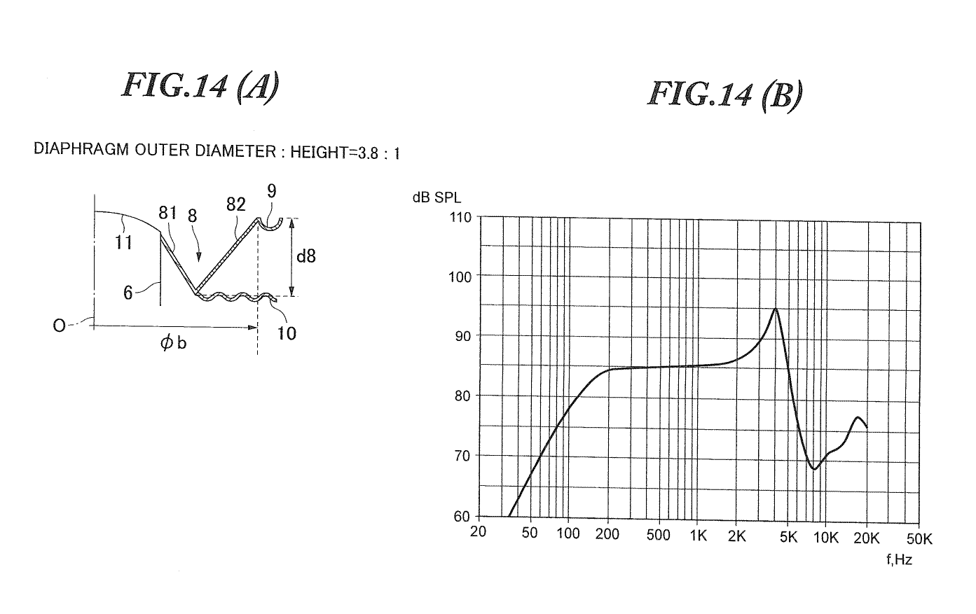

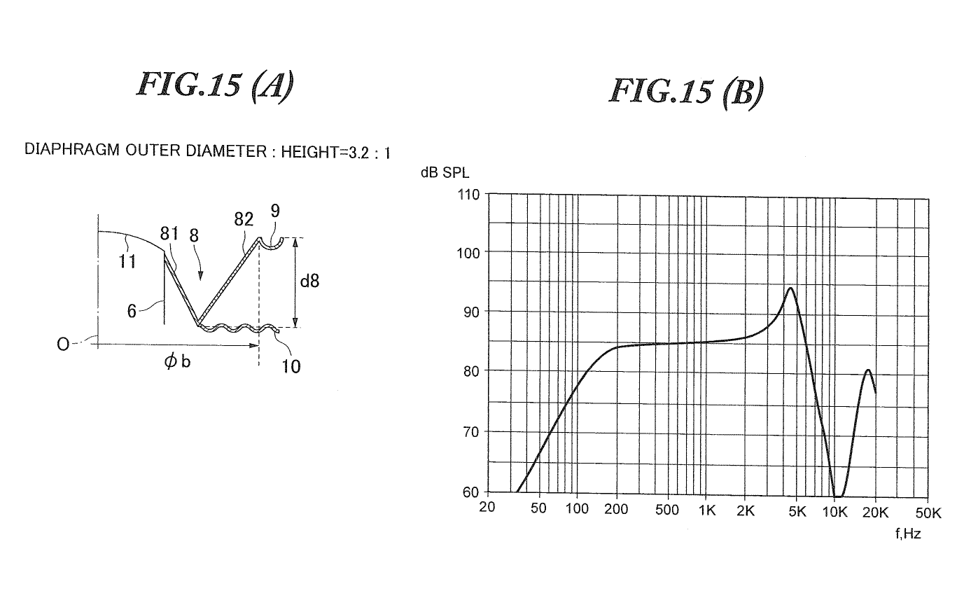

FIG. 13(A) is a diagram showing a diaphragm in which the inner diaphragm portion 81 is formed with a cross section of generally straight shape and the outer diaphragm portion 82 is formed with a cross section of generally straight shape, the outer rim of the diaphragm being formed with a diameter (outer diameter) 4.8 times the height d8 of the outer rim of the diaphragm. FIG. 13(B) is a chart showing the result of simulation on the sound pressure level of the speaker device which uses the diaphragm shown in FIG. 13(A). FIG. 14(A) is a diagram showing a diaphragm in which the inner diaphragm portion 81 is formed with a cross section of generally straight shape and the outer diaphragm portion 82 is formed with a cross section of generally straight shape, the outer rim of the diaphragm being formed with a diameter (outer diameter) 3.8 times the height d8 of the outer rim of the diaphragm. FIG. 14(B) is a chart showing the result of simulation on the sound pressure level of the speaker device which uses the diaphragm shown in FIG. 14(A). FIG. 15(A) is a diagram showing a diaphragm in which the inner diaphragm portion 81 is formed with a cross section of convex shape and the outer diaphragm portion 82 is formed with a cross section of generally straight shape, the outer rim of the diaphragm being formed with a diameter (outer diameter) 3.2 times the height d8 of the outer rim of the diaphragm. FIG. 15(B) is a chart showing the result of simulation on the sound pressure level of the speaker device which uses the diaphragm shown in FIG. 15(A).

Next, as shown in FIGS. 13(A) and 13(B) to 15(A) and 15(B), the outer diameter and the height of the diaphragm and the height are optimized.

As shown in FIG. 13(A), when the inner diaphragm portion 81 is formed with a cross section of generally straight shape and the outer diaphragm portion 82 is formed with a cross section of generally straight shape, and the outer rim of the diaphragm is formed with a diameter (outer diameter) 4.8 times the height d8 of the outer rim of the diaphragm, the diaphragm has a deteriorated high-frequency characteristic as compared to the other cases as shown in FIG. 13(B).

On the other hand, when the outer rim of the diaphragm 8 is formed with a diameter (outer diameter) 3.8 times or 3.2 times the height d8 of the outer rim of the diaphragm as shown in FIGS. 14(A) and 15(A), the diaphragms have an improved high-frequency characteristic as compared to the other case.

It is therefore desirable to use a diaphragm 8 which is shaped, for example, so that the diameter (outer diameter) of the outer rim of the diaphragm 8 is smaller than or equal to approximately four times the height d8 of the outer rim of the diaphragm, or smaller than or equal to approximately 3.8 times or 3.2 times in particular.

As has been described, the speaker device 100 according to the present invention includes the diaphragm 8 having the inner rim 8a connected to the voice coil bobbin 6 and the outer rim 8b connected to the frame 5 through the edge 9, wherein the diaphragm 8 is shaped so that the peak portion 8c is formed between the inner rim 8a and the outer rim 8b, which are positioned at the acoustic radiation side in comparison with the peak portion 8c. Further, the cross-sectional shape of the diaphragm 8 extending from the peak portion 8c to the inner rim 8a is formed with convex shape toward the acoustic radiation side; and the cross-sectional shape of the diaphragm 8 extending from the peak portion 8c to the outer rim 8b is formed with a substantially straight shape or a convex shape toward the acoustic radiation side. These features of the diaphragm 8 allow high-quality sound to reproduce, and the high frequency characteristic of sound pressure level to be improved, even if the diaphragm is reduced in profile.

Besides, the diaphragm 8 has the peak portion 8c between the inner rim 8a and outer rim 8b which are positioned at the acoustic radiation side in comparison with the peak portion, and the length from the inner rim 8a to the peak portion 8c along a direction of diameter of the speaker device is formed smaller than the length from the peak portion 8c to the outer rim 8b along the same direction of diameter. These features of the diaphragm 8 allow high-quality sound to reproduce, in particular, the high frequency characteristic of sound pressure level to be improved, even if the diaphragm is reduced in profile.

Besides, the diaphragm 8 has the peak portion 8c between the inner rim 8a and outer rim 8b, which are positioned at an acoustic radiation side in comparison with the peak portion, and also the outer rim 8b of the diaphragm 8 is formed with a diameter equal to or less than four times of the height in the outer rim 8b of the diaphragm 8. These features of the diaphragm 8 allow high-quality sound to reproduce, in particular, the high range frequency characteristic of sound pressure level to be improved, even if the diaphragm is reduced in profile.

Besides, it is possible to improve a higher frequency characteristic of sound pressure level and to reproduce high-quality sound by producing a diaphragm under either condition or the combination of all the conditions as follows.

1. The cross-sectional shape between the inner rim 8a and the peak portion 8c of the diaphragm 8 is formed with a convex shape toward the acoustic radiation side. And the cross-sectional shape of the outer rim side extending from the peak portion is formed with a substantially straight shape or a convex shape.
2. The length of the diaphragm 8 extending from the inner rim 8a side to the peak portion 8c along the direction of diameter of the speaker device is formed smaller than the length of the diaphragm 8 extending from the peak portion 8c to the outer rim 8b in the same way.
3. The outer rim 8b of the diaphragm 8 is formed with a diameter equal to or less than four times of the height of the outer rim 8b of the diaphragm 8.

As has been described, the speaker device 100 according to the present invention includes: the diaphragm 8 which has the inner rim 8a connected to the voice coil bobbin 6 and the outer rim 8b connected to the frame 5 through the edge 9, and is shaped so that the peak portion 8c is formed between the inner rim 8a and the outer rim 8b, which are positioned at the acoustic radiation side in comparison with the peak portion 8c; and the inner magnet type magnetic circuit 4 for driving the voice coil 7 which is arranged on the voice coil bobbin 6 connected to the inner rim 8a of the diaphragm 8. As compared to, for example, a magnetic circuit of outer magnet type, the speaker device 100 according to the present invention can thus be made smaller than heretofore in size, in profile, and in weight since the speaker device has the magnets 3 in its center.

The use of the repulsion magnetic circuit improves the magnetic efficiency, which allows high-quality sound reproduction.

The inner magnet type magnetic circuit 4 includes: the magnet 3 (31); the plate 2 (21) which is arranged on the magnet 3 (31); and the yoke 1 which is shaped to spread out radially from the bottom portion 1a connected to the bottom of the magnet 3 (31), bend to the direction of acoustic radiation, and extend to beside the plate 2 (21). The structure that the magnet 3 (31) is surrounded with the yoke 1 and the frame 5 made of an iron material or the like can prevent magnetic leakage.

The yoke 1 and the frame 5 for preventing magnetic leakage can also be reduced in thickness. This translates into a lighter weight.

The outer rim 10a of the damper 10 is connected to the frame 5, and the peak portion 8c of the diaphragm 8 is supported by the inner rim 10b of this damper. The damper 10 can thus support the peak portion 8c of the diaphragm 8 so as to be capable of vibrations. Since the peak portion 8c of the diaphragm 8 is set to the height of the damper 10, it is possible to reduce variations in the height of the peak portion 8c of the diaphragm 8, thereby allowing high-quality sound reproduction. Setting the peak portion 8c of the diaphragm 8 to the height of the damper 10 also improves assembly workability.

Since the inner magnet type magnetic circuit 4 uses a repulsion magnetic circuit, the speaker device 100 can be reduced in size and in profile even with the effects that it is possible to improve the magnetic flux density in the magnetic gap 4g, it is possible to improve the force for driving the diaphragm 8, it is possible to reproduce sound in high quality, and so on.

The yoke 1 arranged around the inner magnet type magnetic circuit 4 has the slope portion 1d which is formed on the outer corner of the end of the side portion 1b of the yoke 1 at the acoustic radiation side. It is therefore possible to improve the magnetic flux density in the magnetic gap 4g and improve the force for driving the diaphragm 8 further.

As described above, the speaker device 100 has the inner magnet type magnetic circuit 4 which includes the magnet (s) 3, the plate (s) 2, and the yoke 1. The voice coil 7 is supported by the voice coil bobbin 6 and the diaphragm 8 so as to be capable of vibrations in the magnetic gap 4g between the outer periphery of the plate 2 (21) and the inner periphery of the yoke 1. The voice coil 7, the plate 2 (21), the peak portion 8c of the diaphragm 8, and the damper 10 are formed so as to be generally flush with each other. The end of the side portion 1b of the yoke 1 at the acoustic radiation side falls on the acoustic radiation side with respect to the peak portion 8c of the diaphragm 8, and the slope portion 1d is formed on the end of the yoke 1. This makes it possible to reduce the speaker device 100 in size and in profile.

The present invention is not limited to the embodiment described above. The foregoing embodiment and concrete examples may be combined with each other.

Although, in the foregoing embodiment, the magnetic circuit 4 uses a repulsion magnetic circuit as shown in FIG. 2, it is not limited to this configuration. For example, a magnetic circuit having such a structure as shown in FIG. 3 can be used to make the speaker device even smaller in profile and in size.

While the present invention has been described in connection with the preferred specific embodiments thereof, it will be understood that the description is intended to illustrate and does not limit the scope of the present invention, which is defined just by the following claims.

What is claimed is:

1. A speaker device having a frame, a diaphragm including an inner rim connected to a voice coil bobbin and an outer rim connected to the frame through an edge, and a damper including an outer rim connected to the frame,
the diaphragm comprising:
a peak portion formed with an acute angle folded back between said inner rim and said outer rim in the diaphragm wherein said inner rim and said outer rim are positioned at an acoustic radiation side in comparison with said peak portion,
wherein a cross-sectional shape of said diaphragm between said peak portion and said inner rim side is formed with a convex shape toward the acoustic radiation side, and a cross-sectional shape of said diaphragm between said peak portion and said outer rim side is formed with a substantially straight shape or a convex shape toward the acoustic radiation side, and
wherein said peak portion is connected to the damper at near an inner rim of the damper.

2. The speaker device according to claim 1, wherein:
a length along a diameter direction of the speaker device from said inner rim to said peak portion is smaller than the length along a diameter direction from said peak portion to said outer rim.

3. The speaker device according to claim 1, wherein:
said outer rim of said diaphragm has a diameter equal to or smaller than four times of a height of said outer rim of said diaphragm.

4. A speaker device having a frame, a diaphragm including an inner rim connected to a voice coil bobbin and an outer rim connected to the frame through an edge, and a damper including an outer rim connected to the frame,
the diaphragm comprising:
a peak portion formed with an acute angle folded back between said inner rim and said outer rim in the diaphragm wherein said inner rim and said outer rim are positioned at an acoustic radiation side in comparison with said peak portion,
wherein said peak portion is connected to the damper at near an inner rim of the damper, and
wherein a length along a diameter direction of the speaker device from said inner rim to said peak portion is smaller than the length along the diameter direction from said peak portion to said outer rim.

5. A speaker device having a frame, a diaphragm including an inner rim connected to a voice coil bobbin and an outer rim connected to the frame through an edge, and a damper including an outer rim connected to the frame,
the diaphragm comprising:
a peak portion formed with an acute angle folded back between said inner rim and said outer rim in the diaphragm wherein said inner rim and said outer rim are positioned at an acoustic radiation side in comparison with said peak portion,
wherein said peak portion is connected to the damper at near an inner rim of the damper, and
wherein said outer rim of said diaphragm has a diameter equal to or smaller than four times of a height of said outer rim of said diaphragm.

6. The speaker device according to claim 5,
wherein said height of the outer rim of said diaphragm is equal to a distance extending from said peak portion of said diaphragm to said outer rim of said diaphragm along a direction of the acoustic radiation.

7. The speaker device according to claim 1,
wherein said speaker device has an inner magnet type magnetic circuit for driving a voice coil arranged on said voice coil bobbin.

8. (canceled)

9. The speaker device according to claim 4,
wherein said speaker device has an inner magnet type magnetic circuit for driving a voice coil arranged on said voice coil bobbin.

10. The speaker device according to claim 5,
wherein said speaker device has an inner magnet type magnetic circuit for driving a voice coil arranged on said voice coil bobbin.
